(19) United States
(12) Patent Application Publication
(10) Pub. No.: US 2017/0270211 A1
(43) Pub. Date: Sep. 21, 2017

(54) Attraction and Event Guide System and Related Methods

(71) Applicant: Zachary Schwartz, Jacksonville, FL (US)

(72) Inventor: Zachary Schwartz, Jacksonville, FL (US)

(21) Appl. No.: 15/461,416

(22) Filed: Mar. 16, 2017

Related U.S. Application Data
(60) Provisional application No. 62/310,004, filed on Mar. 18, 2016.

(51) Int. Cl. G06F 17/30

(52) U.S. Cl. CPC G06F 17/30867; G06F 17/30991; G06F 17/30598; G06F 17/30241

(57) ABSTRACT

The present disclosure relates to a system and methods for collecting user input and converting them into signals that may affect the strength of recommendations and experiences pushed to users. According to the present disclosure, these signals may inform predictive models and group similar users to make stronger recommendations. The signals may clarify user intent and preference, wherein presentation of experiences may be relevant, filtering out what a user may deem as incorrect, impertinent, or irrelevant information from user input. Signals may be gathered through direct and indirect input from a user, wherein the system may collect, process, and analyze the signals and experiences to be better able to make appropriate recommendations.

### CROSS-REFERENCE TO RELATED APPLICATION

This application claims priority to and the full benefit of U.S. Provisional Patent Application Ser. No. 62/310,004, filed Mar. 18, 2016, and titled “ATTRACTION AND EVENT GUIDE SYSTEM AND RELATED METHODS”, the entire contents of which are incorporated herein by reference.

### BACKGROUND OF THE DISCLOSURE

Typically speaking, human beings are social animals who enjoy being around one another. Traditionally, people would hear about goings-on or events through word of mouth, and would attend accordingly. Depending on the person's social status, formal invitations might also be extended through the post. These traditions continue to this day, with wedding invitations being mailed in special envelopes or with local, small-scale events growing due to positive word of mouth. Most people trust one another when it comes to trying something new and to add variety into what might otherwise be daily routine. As such, some people are always on the lookout for upcoming events or for new experiences they can have.

Organizations and companies are aware of this human tendency of seeking out new experiences. As a result, many invest in marketing to promote themselves and bring awareness to what they are doing. This can come in the form of organized events, promotions, fundraisers, shindigs, announcements, donations, or a combination thereof. Traditionally, this might have been in the form of flyers, coverage in a newspaper, or taking out an advertisement. The hope was ultimately affecting public perception and discourse and directing people towards whatever it was the organization or company was promoting. Marketing also served to define a target audience, test the market, or identify influence on consumer behavior.

As more corporate interests started bubbling up and getting more organized, so, too, did the organic equivalent between communities. Enthusiasts started curating community events boards; creating event leaflets, pamphlets, and flyers to promote accordingly; and putting together events magazines to collect everything that was happening locally during that day, week, or month, depending on volume, demand, and interest. Local newspapers would also join to promote events depending on its popularity or importance to the community. The act of collecting events for public information would eventually become a specialized pursuit unto itself, with publishers joining the fray and developing magazines centered around the events occurring in densely populated cities, like New York or London.

However, not every city garners the attention or has the population to have a publication dedicated to its events. Further, if someone is traveling, they might not know what publications to turn to when determining what to do at a travel destination or on their way there. Aside from that, not every publication will incorporate every single event going on, typically because they are unaware of certain events. The advent of the internet facilitated these concerns, allowing quick access to do research before arriving at towns and cities. Now, participants could see restaurants, tourist attractions, and events before arriving, just in case they wanted to plan around those. Over time, online communities could leave reviews to further help someone in making a decision. Search engines also started featuring sponsored or promoted recommendations in paid-for advertisements to influence these decisions. The internet also gave local communities ways to start promoting their own events at little or no cost, which a person could then check out. Social media replaced word of mouth as a way of generating goodwill and organic coverage of an event.

Mobile applications further simplified ease of access to event information. Now no longer confined to a computer, people can access numerous resources at the tips of their fingers. This makes searching for things to do in a hometown easier, supplementing the traditional model with something on the go that was also instantly accessible. This also facilitates spontaneous experimentation that veers from routine for those interested in doing so while also providing a somewhat reliable rubric for making those determinations. However, the mobile applications have adapted the appearance and sorting structure of its online-based companions, making it difficult for people to sort through. This complexity detracts from the base purpose of these applications: to encourage people to go out, try new things, and enjoy themselves.

### SUMMARY OF THE DISCLOSURE

What is needed is a system and related methods to more easily make a determination as to what events, attractions, or options are available to a user and to make it even easier for a user to act on that desire. This system may collect user preferences, and, over-time, become more confident in recommending certain activities to this user. This system may also cross-reference the user's interests with other users who have similar interests, and make recommendations accordingly. The system can then organically populate or bubble up events that would be useful to the user, as well as facilitate a means for vendors to accurately target those who might be interested in what they are doing and offer limited, exclusive offers or discounts to users who are more prone to act on it.

This system may offer a dynamic interface that gathers user input in a variety of ways that then feeds back into the system to better inform the system of a user's likes and dislikes. With real-time user input, the system will collect positive and negative signals from users to enhance itself when searching the database for what might be appropriate to populate and push to a user. Organically, over time, this system may project what are the most popular events based on user interest, may recommend events based on both collective and individual interest, and collectively suggest an itinerary to an individual or group for more than one recommended activity. This itinerary may be generated by the system itself or populated by the users, which the system would then use to consider their priorities, preferred order of activities, and what each member of the group prefers, and find a common middle-ground that group users would be satisfied with. This system may be available on a variety of platforms, such as a smartphone, mobile devices, computers, laptops, internet browsers, or independent consoles, by way of non-limiting examples.

The present disclosure relates generally to a system of one or more computers that may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by a data processing apparatus, cause the apparatus to perform the actions.

One general aspect includes a computing system to provide an experience guide service, the computing system including a display; one or more wireless communication interfaces; and one or more memory resources. The computing system may include an experience database configured to store a plurality of experiences. The computing system may also include a signal database configured to store a plurality of sets of signals from a plurality of users and one or more processors.

The computing system may collect experience data from one or more sources, where the experience data includes one or both objective and subjective information about each of the plurality of experiences. In some aspects, the computing system may collect signal data from a plurality of users, where a first user of the plurality of users may be associated with a first set of signals. The computing system may assign a first user value set to at least a first experience set of the plurality of experiences, where the first user value is calculated from the first set of signals. The computing system may present the first experience set, where the presentation is based on the first user value set. Some embodiments of this aspect include corresponding computer systems, apparatus, and computer programs recorded on one or more computer storage devices, each configured to perform the actions of the methods.

Implementations may include one or more of the following features. In some aspects, the one or more processors may be configured to curate the experience data, where the curation evaluates the one or both objective and subjective information. In some embodiments, the evaluation may verify the objective information. The evaluation may associate the plurality of experiences with predefined categories based on the one or both objective and subjective information. The one or more processors may be configured to curate the experience data, where the curation may isolate categories of objective parameters from the objective information about each of the plurality of experiences. The curation may validate the objective information about each of the plurality of experiences. The curation may isolate categories of the subjective information about each of the plurality of experiences and may assign category tags to each of the plurality of experiences. In some aspects, a first user value set may be assigned to the category tags. The presentation of the first experience set may be based on the category tags.

The method may comprise the steps of: presenting a first experience from the plurality of experiences, where the prompting of at least one signal includes a direct value indication for the first experience. In some aspects, the direct value indication may include a directional slide of the presented first experience, where each direction indicates a different qualitative value. The method may further include the method steps of: receiving a seed signal from the first user, where the associating of the first user with the first user group is further based on the seed signal.

The method may further include the method steps of: prompting direct filtering based on the predefined category tags. In some aspects, the method steps may comprise predicting a third set of user values for the plurality of experiences based on the correlation of the first set of signals with the predefined category tags and the second set of user values. The method may further include the method step of associating the subjective information with predefined category tags and correlating the first set of signals with the predefined category tags. The method may include the method steps of: associating the first user with a first user group based on an overlap between at least part of the first set of signals and at least part of a first user group set of signals and retrieving a second set of user values associated with the first user group, where the presentation of at least the portion of the plurality of experiences is further organized based on the second set of user values.

In some implementations, the method may further include the method steps of: prompting direct input of objective parameters, where the presentation is one or both further organized or filtered based on the objective parameters. The positive qualitative value may be weighted as more or less positive based on a received input from the first user. The qualitative values may include one from the set of: positive, negative, or neutral. Implementations of the described techniques may include hardware, a method or process, or computer software on a computer-accessible medium.

One general aspect may include a method for presenting experience data, the method being performed by one or more processors and including the method steps of: accessing an experience database including a plurality of experiences, where the experience database includes one or both objective and subjective information about each of the plurality of experiences; prompting signal input from a first user; receiving a first set of signals from the first user; assigning qualitative values to each signal within the first set of signals; correlating the first set of signals to at least a portion of the plurality of experiences, where the correlation is based on the qualitative values and the one or both objective and subjective information; assigning a first set of user values to at least the portion of the plurality of experiences, where the first set of user values are based on a strength of the correlation; and presenting at least the portion of the plurality of experiences, where the presentation is organized based on the first set of user values. Other embodiments of this aspect include corresponding computer systems, apparatus, and computer programs recorded on one or more computer storage devices, each configured to perform the actions of the methods.

Implementations may include one or more of the following features. The method may include the method steps of: presenting a first experience from the plurality of experiences, where the prompting of at least one signal includes a direct value indication for the first experience. In some aspects, the direct value indication may include a directional slide of the presented first experience, where each direction indicates a different qualitative value. The method may include the method steps of: receiving a seed signal from the first user, where the associating of the first user with the first user group is further based on the seed signal. The method may comprise the method steps of: prompting direct filtering based on the predefined category tags.

In some embodiments, the method may comprise the method steps of: predicting a third set of user values for the plurality of experiences based on the correlation of the first set of signals with the predefined category tags and the second set of user values. The method may include the method steps of: associating the subjective information with predefined category tags and correlating the first set of signals with the predefined category tags. The method may further include associating the first user with a first user group based on an overlap between at least part of the first set of signals and at least part of a first user group set of signals and retrieving a second set of user values associated with the first user group, where the presentation of at least the portion of the plurality of experiences is further organized based on the second set of user values.

In some aspects, the method may include prompting direct input of objective parameters, where the presentation is one or both further organized or filtered based on the objective parameters. The positive qualitative value may be weighted as more or less positive based on a received input from the first user. In some implementations, the qualitative values may include one from the set of: positive, negative, or neutral. Implementations of the described techniques may include hardware, a method or process, or computer software on a computer-accessible medium.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary process flowchart for generating initial experiences, according to some embodiments of the present disclosure.

FIG. 2 illustrates an exemplary process flowchart for populating experiences, according to some embodiments of the present disclosure.

FIG. 3 illustrates an exemplary embodiment of an experience filtering system.

FIG. 4 illustrates an exemplary embodiment of a deck card presentation.

FIG. 5 illustrates an exemplary embodiment of a deck card presentation.

FIG. 6A illustrates an exemplary embodiment of a category presentation.

FIG. 6B illustrates an exemplary embodiment of a sub-category presentation.

FIG. 7A illustrates an exemplary embodiment of a profile presentation.

FIG. 7B illustrates an exemplary embodiment of a location interface.

FIG. 7C illustrates an exemplary embodiment of a location interface.

FIG. 7D illustrates an exemplary embodiment of a location interface.

FIG. 8A illustrates an exemplary embodiment of a set radius.

FIG. 8B illustrates an exemplary embodiment of a set radius.

FIG. 9 illustrates an exemplary block diagram of an embodiment of a mobile device.

FIG. 10 illustrates an exemplary processing and interface system.

FIG. 11 illustrates an exemplary processing and interface system.

### DETAILED DESCRIPTION

The present disclosure relates to a system and methods for collecting user input and converting them into signals that may affect the strength of recommendations and experiences pushed to users. According to the present disclosure, these signals may inform predictive models, group similar users to make stronger recommendations, and clarify user intent by avoiding what otherwise might be incorrect, impertinent, or irrelevant information from user input. This is achieved in the method by which a user notes his or her preferences. The system then feeds these preferences back to its servers, where it is collected and analyzed to be better able to make appropriate recommendations.

In some aspects, the present disclosure provides for different methods of presenting user preferences back to the user based on a variety of factors, such as direct input, personal contacts or connections, and users with similar preferences. Users may share these recommendations with others who may also have an interest. The system may pull from various sources or servers to create individualized recommendations or itineraries for users. In the following sections, detailed descriptions of examples and methods of the disclosure will be given.

In the following sections, detailed descriptions of examples and methods of the disclosure will be given. The description of both preferred and alternative examples, though thorough, are exemplary only, and it is understood that to those skilled in the art variations, modifications, and alterations may be apparent. It is therefore to be understood that the examples do not limit the broadness of the aspects of the underlying disclosure as defined by the claims.

### Glossary

Signal: as used herein, refers to a direct input that may inform the system of preferences for categories, experience types, or other experience parameters. A positive signal may indicate a preference in favor of a particular experience parameter, giving more weight to experiences within those parameters. A super positive signal may indicate an absolute preference for a particular experience or experience parameter, giving more weight to experiences within those parameters more so than a positive signal might. A negative signal may indicate a preference away from particular experience parameters, giving less weight or even eliminating experiences within those parameters. A neutral signal may be ignored as a signal or may be stored to present again, such as a skipped experience or reminder for an experience. These signals may be data collection points for user preferences. These signals may be used to inform a system's predictive models. Signals may be used to properly group user preferences to recommendations ranked by the system itself. As signals may be collected, the system may make recommendations with more confidence as a more complete user profile is created. Signals may be primarily collected via direct user input, though signals may be informed by other supplemental sources, such as current location or profiles linked through third-party vendors.

Seed Signal: as used herein, refers to an initial input set used to populate the initial suggestions for a user. For example, this may be a quiz that asks a user about his or her preferences. Depending on the answers a user provides, an initial set of experiences may be populated to verify whether it is true to what a user answered. The seed signal may determine which user group to associate with the user, wherein the association may set user group preferences as the default preferences for the user, evolving as more signals may be received from the user.

Secondary Signal: as used herein, refers to an indirect input that may inform the system of preferences. Secondary signals may be discerned from user activity, such as through social media accounts, travel patterns, purchases, or web browsing history, depending on the access permissions granted.

Experience: as used herein, refers to something affording amusement, entertainment, or enjoyment in some fashion, including, but not limited to, events, attractions, diversions, restaurants, venues, or retail.

Curator: as used herein, refers to a mechanism that may directly populate events into the system. Curators may research local events on an hourly, daily, weekly, monthly, quarterly, or yearly basis to add to the system. Curators may sort through both user or business requested or submitted experiences to determine what is appropriate for the system. These experiences may be described and categorized for the system to read and pull to transmit to a user based on their preferences. The general role of the curator may be to ensure the accuracy and quality of experience data. In some aspects, a curator may be an individual who manually reviews and inputs experience data. In some implementations, a curator may comprise an automated mechanism.

Recipe: as used herein, refers to a collection of experiences collated for or by a user, wherein the collection may comprise a congruous set of experiences centered around a theme or experience parameters. Presented recipes may be ranked depending on a variety of factors, such as, for example, user's geographic location, the weather, the time of day. Recipes may be created by the system based on one or more user preferences, trending experience grouping, popular grouped experiences, pulling together from different streams or servers. Recipes may also be created by the user themselves, who may begin to plan a night of experiences and want to maintain the list for later use and planning. Recipes may be recommended by other users or get highlighted due to popular demand or community interest. Recipes may also be static and shared through other software or systems, such as, for example, SMS, text messages, or a website.

Ingredient: as used herein, refers to individual experiences that may be implemented into a recipe.

Explore Interface: as used herein, refers to a graphical user interface (GUI) that users may manipulate to state their preferences that inform the system. An initial seed signal may be generated here that affects those that follow. The explore interface may then generate ingredients that a user then interacts with using positive and negative signals.

Meta-Category: as used herein, refers to categories of experiences that may be associated with particular preference data. In some aspects, meta-categories within a particular category may imply overlapping preferences between experiences.

Guide Me Interface: as used herein, refers to a GUI where users may search and locate experiences based on categories. A meter lets a user know how confident the system is in making a recommendation. The guide me Interface may generate experiences within each category based on user preferences and may separate for a user experiences they may be likely to enjoy and events they may enjoy. A user may tweak these recommendations based on a variety of factors, such as a location radius, further meta-categories, or time.

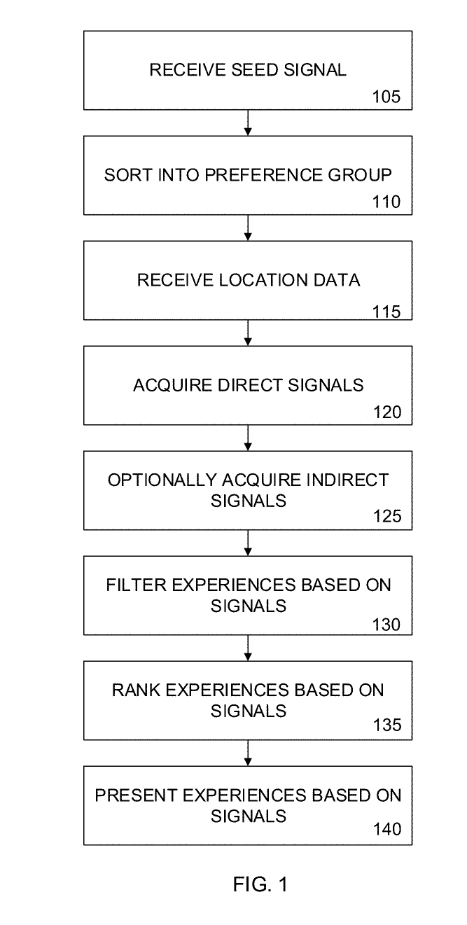

Referring now to FIG. 1, an exemplary process flowchart for generating initial experiences is illustrated. At 105, seed signals may be received. At 110, seed signals may be sorted into preference groups. At 115, location data may be received. At 120, direct signals may be acquired. In some embodiments, at 125, indirect signals may be acquired. At 130, experiences may be filtered based on signals. At 135, experiences may be ranked based on signals. At 140, experiences may be presented based on signals.

In some embodiments, at 105, a user may be prompted with a series of questions that may establish their seed signal to determine their user group preferences. In some implementations, these questions may be tied to a personality quiz. In some aspects, a user may be directly given a set of experiences to make decisions about. In some embodiments, the seed signal may then affect the next set of experiences presented. In some implementations, as a user makes decisions about experiences providing further signals, the preference sets may be more accurately tailored based on previous decisions made or actions taken by the user. In some aspects, certain actions or signals may be weighed differently in the system for generating the next set of experiences.

In some embodiments, seed signals may be included in an average representation of an experience based on personality factors, age, or gender. In some implementations, each experience may be assigned an average demographic representation which can be used to generate future recommendations for a first time user.

In some embodiments, an experience may be assigned a value corresponding to how similar an experience is to other experiences within a category. In some implementations, an experience may be assigned a value based on the activity's popularity among other users. In some aspects, a list of experiences liked by a similar user base or user profile type may be filtered by categorical criteria to generate more targeted recommendations without a specific user context.

In some embodiments, a value may be assigned to an experience for a specific user by measuring the user's signals within a certain criteria to measure the similarity of those signaled experiences to an individual activity being scored. In some implementations, the similarity measures may be collated and normalized to be used as a factor in the final value of the activity for the user.

For example, a positive signal received for a particular Italian restaurant may be more heavily weighted than a negative or neutral signal received for another Italian restaurant. Negative signals may indicate a dislike of the particular restaurant, such as their food, ambience, or service, wherein a positive signal for a similar experience may indicate an overall preference for that experience type in addition to a preference for the particular Italian restaurant. A user may also elect to make a “super positive” signal to indicate to the system to weigh an interaction even more heavily than a positive signal may be weighed. In some implementations, a super positive signal may reduce the amount of false positive classifications of activities to offer to a user. In some aspects, negative signals and neutral signals may be treated similarly, wherein the signals may be ignored or may attach to an experience parameter prompting a removal of experiences within that experience parameter. In some aspects, the removal may be overridden in the future by subsequent positive signals or manual adjustment of preferences.

In some embodiments, a user may elect to supplement their initial answers with more information about themselves. In some implementations, a user may do this by linking their profile with a third-party application where they may have more information stored. For example, a user may grant access to their social media profile(s), where they may have indicated preferences within that other profile. In some embodiments, the system may then generate tailored experiences based on these preferences. In some implementations, the system may convert these third-party preferences into signals to supplement further recommendations.

In some aspects, a user may also grant access to secondary signals, such as, for example, their location and current weather. In some embodiments, secondary signals may generate experiences that may be closer to the user or more appropriate for certain times of day or weather. For example, a water park or amusement park may not be an appropriate recommendation when it is snowing or raining throughout the day.

In some implementations, new activities may be evaluated against a user's existing model or profile. In some aspects, new activities may be assigned probabilities of falling into a positive or negative signal class. In some embodiments, the probability of a positive signal may be used as a factor in rating the activity for the user.

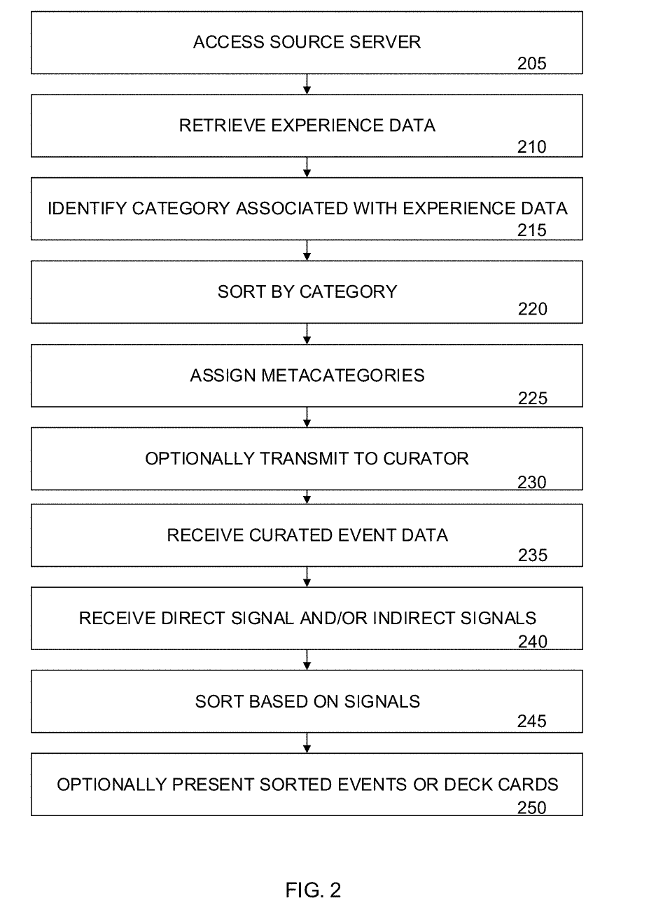

Referring now to FIG. 2, an exemplary process flowchart for populating experiences is illustrated. At 205, a source server is accessed. At 210, experience data is retrieved. At 215, categories associated with experience data may be identified. At 220, experience data is sorted by category. At 225, meta-categories may be assigned. In some aspects, at 230, experience data is transmitted to a curator. At 235, curated event data is received. At 240, direct and/or indirect signals may be received. At 245, experiences may be sorted based on signals. In some embodiments, at 250, sorted events or deck cards may be presented.

In some implementations, a curator may research activity information from online, print, and local sources to compile into a list of activities by meta-category. In some aspects, a curator may upload the activities, which are then geographically tagged or merged with existing locations within a curation database. In some embodiments, these activities are assigned to a curator to queue for full curation. In some implementations, full curation may include adding a description, hours of availability, informational links, adding social media connection information, or adding photographs or videos, as non-limiting examples. In some aspects, a curator may push or publish an activity. In some embodiments, a migration system may validate a curator's data. In some implementations, an activity may be moved from a curation database to a live user-facing core database. In some aspects, a curator may be notified if a validation error occurs. In some embodiments, if a validation error occurs, an activity may be returned to the curator to correct. In some implementations, once an activity passes validation, an activity may be indexed and accessible by users.

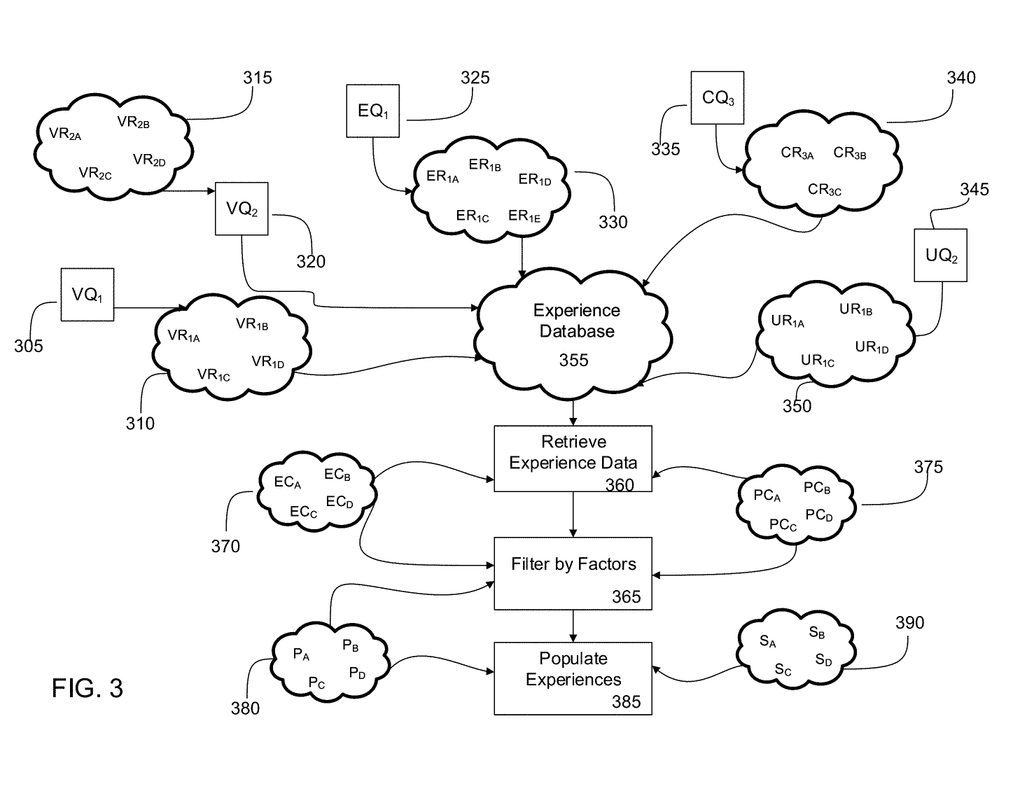

Referring now to FIG. 3, an exemplary experience filtering system 365 is illustrated. In some embodiments, a vendor 305 may create vendor experience data 310. In some implementations, a vendor 305 may feed this experience data directly to the experience database 355. In some aspects, the experience database 355 may monitor vendor servers for vendor experience data 310 and aggregate the vendor experience data 310 within the experience database 355. In some implementations, vendor experience data 315 may have already been created in a separate server or previously existed. In some aspects, a vendor 320 may retrieve this data and input the vendor experience data 315 into the experience database 355. In some embodiments, a vendor 320 may retrieve experience data that previously existed and feed it into the experience database. For example, a vendor 320 may be co-sponsoring an experience that is not completely hosted by them, but would like to promote the experience in some way.

In some aspects, a vendor 320 may aggregate experience data 315 from external servers. For example, a vendor 320 may comprise an entertainment magazine that collects and presents a calendar of events related to the music industry. As another example, a vendor 320 may be a restaurant located in an epicenter for events, wherein the restaurant may aggregate local events in walking distance from the restaurant. In some aspects, experience data may be presented in a calendar view.

In some implementations, an experience organizer 325 may create community experience data 330. In some embodiments, an experience organizer 325 may feed this experience data directly to the experience database 355. In some implementations, the experience database 355 may monitor experience organizer servers for community experience data 330.

In some aspects, a curator 335 may gather curated experience data 340. In some embodiments, a curator 335 may feed this experience data directly to the experience database 355. In some implementations, a user 345 may create user experience data 350.

In some aspects, a user 345 may feed user experience data directly to the experience database 355. In some embodiments, certain authority may be granted to some users to allow for direct input of experience data. For example, a user 345 may comprise a local celebrity, and user experience data 350 may comprise information about a birthday party for people or invitees to attend. A user 345 could create information concerning that event and then enter it into the event database. Once the user experience data 350 is entered, a user 345 may share information about the event to other users. In some implementations, a user 345 would be able to share this experience with other users or other users can search the experience database 355 for information on that user's created experience.

In some aspects, a user 345 may upload media related to an experience, such as images, audio, or video. For example, a user 345 may upload photographs of a restaurant and food served at the restaurant. As another example, a user 345 may upload a video of friends enjoying a concert and a short audio clip of the music played. In some aspects, the amount or types of media that may be uploaded may be limited based on parameters related to the user 345, experience, or other component. For example, a user 345 may have limited permissions based on a subscription level or contribution level.

In some embodiments, the experience database may monitor servers for experience data to populate its systems. In some implementations, a curator 335 may monitor servers to pull and create experiences to feed into the experience database 355. In some aspects, experience data may flow directly to a curator 335 who may then input experience data into the experience database 355. In some implementations, a curator may assign or tag categories and meta-categories to experience data before populating the experience database 355.

At 360, experience data may be retrieved from the experience database 355. At 365, experience data may be filtered by a variety of factors. In some embodiments, experience data may be sorted as a result of curated data 370, user preference data 375, user search results 380, or signals 390, by way of non-limiting examples. In some embodiments, experience data may be presented and sorted based on an objective ordering, such as a sports team game schedule. At 385, experiences may be populated. In some aspects, these experiences may change or fluctuate over time depending on a user's changing preferences. In some implementations, a user may access their signal 390 records and alter them according to their shifting preferences. In some embodiments, this will alter how the experience database populates experiences for a user at any given time.

In some implementations, a user may also request that the experience database supply an experience completely outside the user's usual preferences to try. In some aspects, the filtering system may then pull from lateral sources, such as what community members or peers did when they requested a similar alternative, what their feedback was, and how likely this particular user will enjoy it, before populating the new experience for the user. In some embodiments, certain experiences may be trending, giving the experience more weight within the experience database.

In some aspects, the experience database may create featured content for a user. In some implementations, the experience database may push sponsored content for a user. In some embodiments, users may give feedback on a particular experience, such as a concert by way of non-limiting example, which the experience database may give more or less weight based on community feedback or recommendations. For example, if a majority of users at a concert are enjoying themselves, giving the experience feedback, and recommending the experience to others, the experience database may tag this as a trending event and make other users aware of the experience. In some implementations, a user may set a preference to be notified when these experiences are available around them.

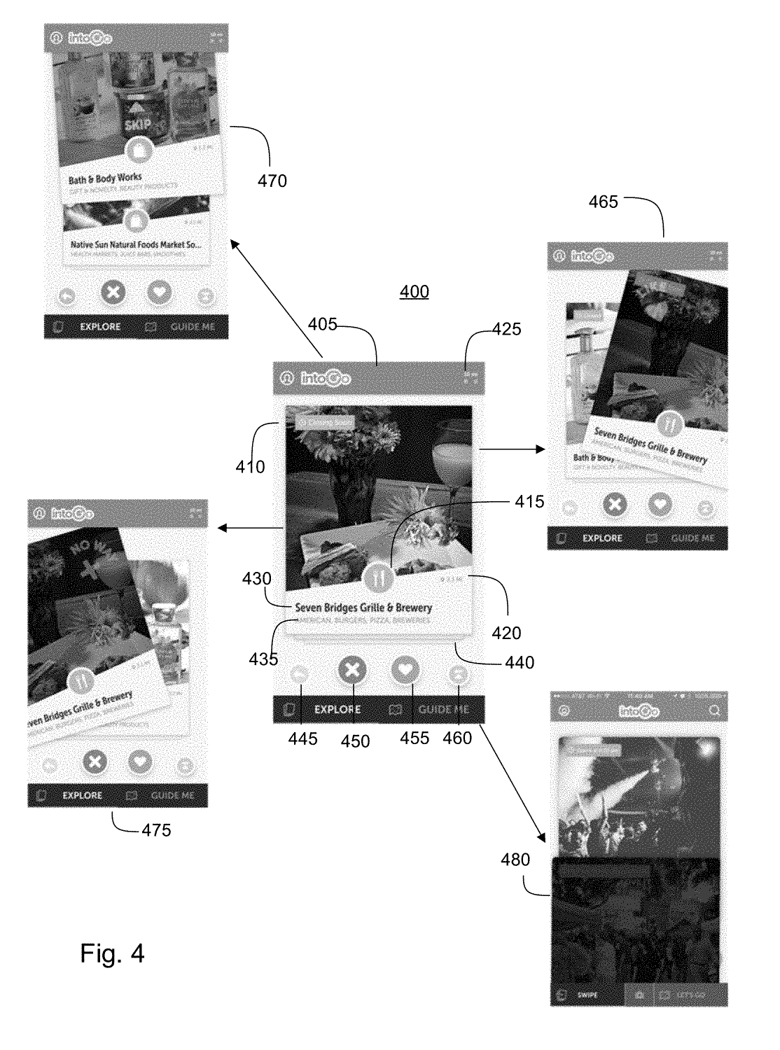

Referring now to FIG. 4, an exemplary embodiment of a deck card presentation 400 is illustrated. In some aspects, a deck card presentation 400 may be available under an explore interface. In some embodiments, a user may be presented with a card 405 with information about an experience available to them. In some implementations, a card 405 may comprise a location advisory message 410, an experience category 415, a location distance 420, a location name 425, and an experience meta-category 435.

In some aspects, the location advisory message 410 may indicate whether a contemplated experience may be open, opening soon, closed for renovation, closing soon, or closed, as non-limiting examples. In some embodiments, the location advisory message 410 may contain community commentary or recommendations on what may be the best or worst times to try an experience. For example, a majority of users may say that there was better service at a restaurant between 4 to 5 p.m.

In some implementations, an icon may indicate an experience category 415 associated with the card 405. In some aspects, these icons may include dining, shopping, nightlife, beauty, hospitality, entertainment, festivals, live music, sports, family, recreation, activities, destinations, outdoor, and pets, as non-limiting examples. In some implementations, a user may see the location distance 420 as they consider their experience options within the deck card presentation 400.

In some aspects, a user may limit their experience options with a location radius 425. In some embodiments, a user may plan ahead for their experience by manipulating their location radius 425 to a place they plan to be in at a certain time. In some implementations, manipulation of the location radius 425 may affect the cards 405 that may be generated into the user's deck card presentation 400. In some implementations, the location name 430 may have an experience meta-category 435 visible in the card 405. In some aspects, a user may click or touch these experience meta-categories 435 to populate experiences that may be similar to those meta-categories. In some embodiments, a user may shuffle through a deck 440. In some implementations, each card 405 in the deck 440 may present information in a uniform manner for the user to consider and compare quickly.

In some aspects, a user may manipulate the card 405 to affect how future experiences will populate. In some embodiments, a user may have an interface with a reconsider option 445, a discard option 450, a keep option 455, and a skip option 460. In some aspects, these options may be manipulated in real-time without guiding icons. In some implementations, each option may inform future cards 405 in the deck 440. In some aspects, the deck 440 may be shuffling other cards 405 to present to the user in real-time. In some embodiments, a user may physically manipulate a card 405 to convey their option choice.

For example, a user may push or slide a card away from them on the screen to use the skip option 460. In some aspects, this skip option 460 may be conveyed by a skip action 470. In some embodiments, a keep option 455 may be conveyed by a keep action 465. In some aspects, a discard option may be conveyed by a discard action 475. In some embodiments, a favorite option may be conveyed by a favorite action 480. In some implementations, a user may have multi-directional inputs to convey their options to the system, wherein each direction may create a signal. In some aspects, different directions may comprise mutually exclusive signals, such as a positive signal in one direction and a negative signal in another direction.

In some implementations, the deck 440 may have multiple cards 405, each generated based on the user's preferences. In some aspects, each card 405 may be generated depending on the signal a user sent when viewing other cards. In some embodiments, as the user manipulates more and more cards, the deck presentation 400 will more accurately approximate and reflect the user's experience preferences.

In some implementations, a deck card presentation 400 and the resulting deck 440 will more effectively pull from an experience database over time with increasing signals. In some aspects, the experience database itself may scan other servers or prompt other severs for different experiences more effectively based on signals and secondary signals. In some embodiments, a user's preferences may be weighed depending on signal collection, such as what options 445-460 and actions 465-475 they take.

In some implementations, an option or action taken within the guide system may be converted into a signal for the system, and actions taken in external systems or third party systems may be converted into secondary signals, wherein secondary signals may carry less influence than a signal. In some aspects, the system may assign a signal value depending on the options and actions a user took and the resulting signals, wherein some options or actions may result in signals that may be worth more than others. In some implementations, the system may assign a signal value to the experience meta-category 435 per user.

For example, if a user consistently makes certain actions on pizzerias, the system may begin to assign a positive or negative value based on those actions, which may inform whether there should be more or less pizzerias within the deck 440 going forward. In some aspects, the guide system may isolate experience data and more precisely assign signals to the isolated experience data. For example, a user may consistently input positive signals for pizzerias, and then suddenly input negative signals for pizzerias. Originally, the guide system may associate positive signals with the entire meta-category of pizzerias, and then with the addition of the negative signals, the guide system may associate positive signals with pizzerias within a particular geo-fenced area and after a certain time. This refinement may prompt the presentation of new experiences in different meta categories but within other similar experience parameters.

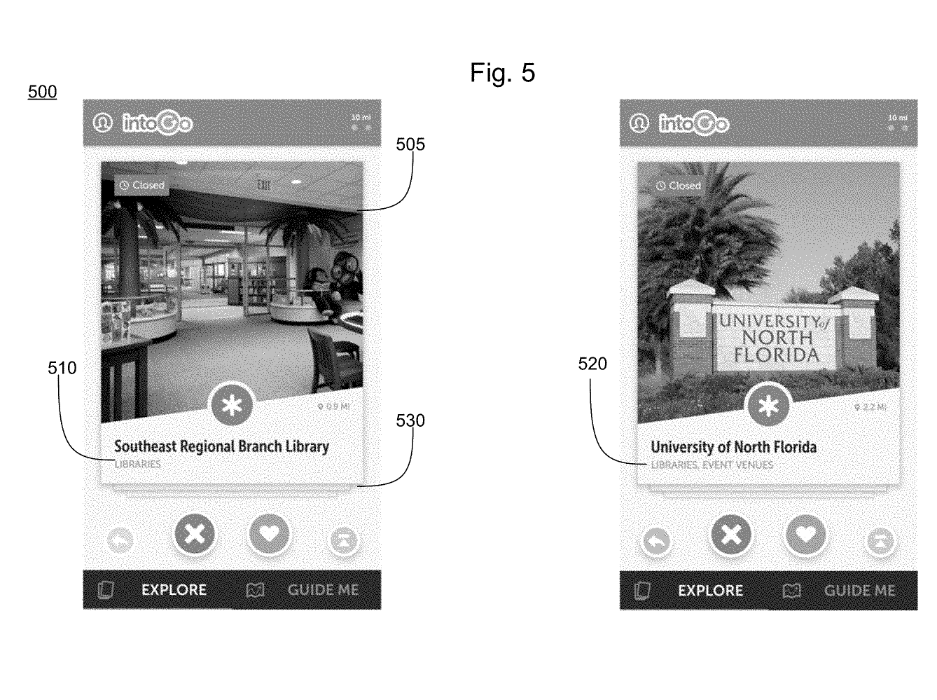

Referring now to FIG. 5, an exemplary embodiment of a deck card presentation 500 is illustrated. In some embodiments, a user may be presented with a card 505 with information about an experience available to them. In some implementations, the card 505 may have a single category 510 for the experience available. In some aspects, the card 505 may present multiple categories 520 for the experience available. In some embodiments, these categories may be organized or created by curators. In some implementations, users may create or recommend categories for experiences. In some aspects, these categories may also be tagged as meta-categories.

In some embodiments, a user may access similar categories by clicking on the category presented by the card 505. In some implementations, a user may see similar experiences within the same category. In some aspects, a user may limit the distance of the category so that they can see what is immediately available to them or farther away. In some embodiments, a user may limit what is shown to those experiences that may be currently available to them instead of an experience that may be closed, for example. In some implementations, a user may choose a category and populate cards within a deck 530 that belong to that category.

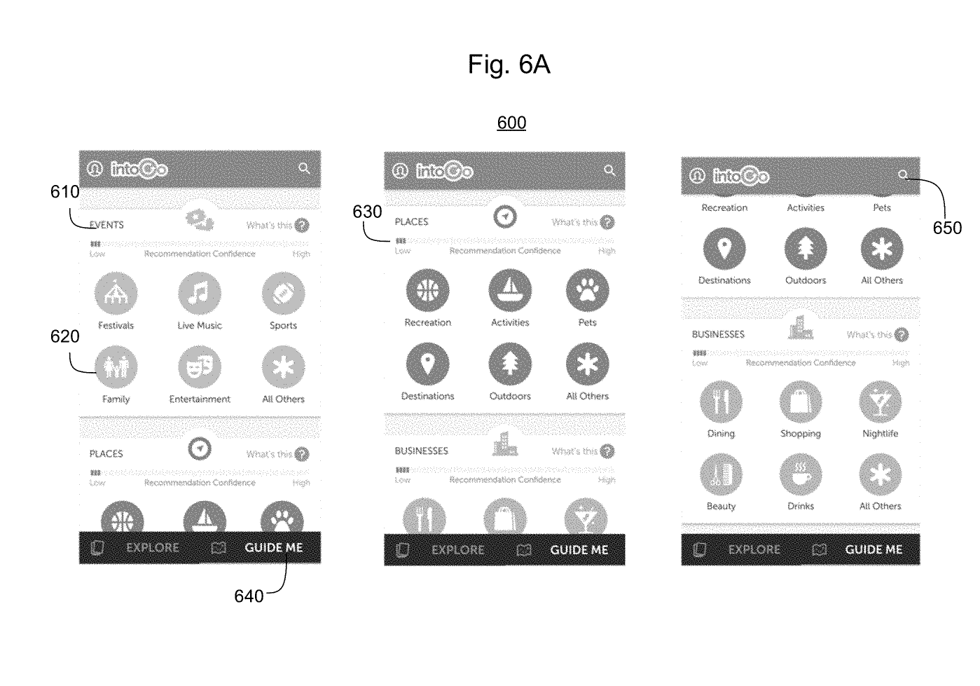

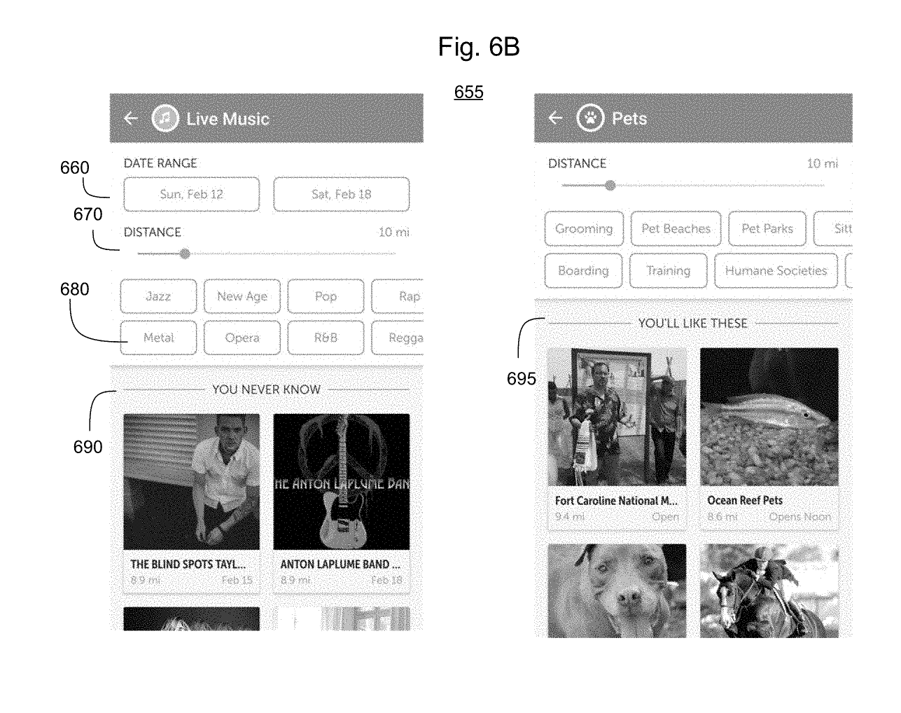

Referring now to FIG. 6A, an exemplary embodiment of a category presentation 600 is illustrated. In some embodiments, a category presentation 600 may be available under a guide me interface 640. In some implementations, a category presentation 600 may display a main category 610 for a user. In some aspects, each main category 610 may contain a sub-category 620 for the user. In some embodiments, a user may click on the sub-category and see meta-categories, as described below in FIG. 6B. In some embodiments, a user may use a search feature 650 to find, define, or narrow search parameters. In some implementations, a sub-category 620 may be grouped with other sub-categories if appropriately related to the same category.

In some aspects, each category 610 may contain a confidence evaluation 630. In some embodiments, the confidence evaluation 630 may be displayed in various forms, such as a meter, a symbol, an alphanumeric value, or a description, as non-limiting examples. In some implementations, the confidence evaluation 630 may dynamically shift pursuant to signals collected or user input and actions. In some aspects, each category may comprise different confidence evaluations depending on how many interactions a user may have had with that particular category. For example, a user may predominantly engage in outdoor experiences, which may raise the confidence evaluation in that category, but may rarely engage in retail experiences, limiting the collection of signals related to retail. In some embodiments, the confidence evaluation may indicate user prioritization of experiences.

Referring now to FIG. 6B, an exemplary embodiment of a sub-category presentation 655 is illustrated. In some embodiments, a sub-category presentation 655 may be available through a guide me interface or within a category presentation, as described above in FIG. 6A. In some implementations, a user may access this view by clicking on a sub-category icon. In some aspects, a user may narrow or expand the scope of available experiences using a date range 660. In some embodiments, a user may narrow or expand the scope of available experiences using a distance calibrator 670.

In some implementations, a user may be able to access a meta-category 680 from within the sub-category presentation 655. In some aspects, a user may click on a meta-category 680 to further narrow what experiences may be populated for them. In some embodiments, a user may click on or combine multiple meta-categories to generate experiences that match those meta-categories. For example, a user may want to attend a concert that features both metal and Japanese pop.

In some implementations, a sub-category presentation 655 may categorize experience results based on a confidence estimate 690, 695. In some aspects, the confidence estimate 690, 695 may state whether a user will or will not enjoy a particular experience, whether a particular experience is a toss-up based on user preferences, or whether a user may want to avoid an experience based on their preferences or previous feedback. In some implementations, a sub-category presentation 655 may recommend other experiences based on a user's interest in a category or sub-category.

In some embodiments, a user may combine individual experiences into an itinerary or a recipe. In some implementations, each independent experience may comprise an ingredient to create a recipe for an itinerary. In some aspects, recipes may be suggested or recommended to a user based on their preferences.

In some embodiments, a user may plan their recipes ahead of time, or they may be recommended in real-time. In some implementations, a user may keep a running list of recipes to access at any time. In some aspects, a user may access a list of recipes, not created by the user, at any time. In some embodiments, this dynamic list may shift based on a variety of factors, such as time of day, weather, location, or other experiences the user is planning, as non-limiting examples. In some implementations, a user may see trending, featured, or sponsored recipes. In some aspects, a user may access a recipe list and re-arrange the order of the experiences contained within the recipes. In some implementations, a user may filter a recipe list based on category of activity.

In some embodiments, a user may excise certain experiences from the recipe. In some implementations, recipes may be advertised as a package deal, where a user may receive a discount, coupon, or give-away by participating in every ingredient in a recipe. In some aspects, a user may share these recipes with other users. In some embodiments, users may alter recipes between themselves in real-time. In some implementations, users may vote on what ingredients remain and what ingredients may be removed. In some aspects, users may share their recipes beyond the system, including on an internet browser, text messages, hyperlink, SMS, smart phones, mobile devices, as non-limiting examples.

For example, a user may plan to go to a movie at night. The user may receive a recommendation of dining experiences in the area to complement the evening. As another example, a user may be planning a date, which may be set to occur on a Friday at 7:00 pm. Date recipes may be accessed and sorted based on those parameters, wherein the most relevant or trending options may float to the top of the list of recipes. Relevance may be based on one or more of adherence to the parameters, popularity of the experiences, preferences based on user signals. For example, a recipe that may include a one-night event may float to the top if that night coincides with the Friday and fits other parameters. If the one-night event is within a category that a user definitively does not prefer, that recipe may be listed after recipes that include preferred categories.

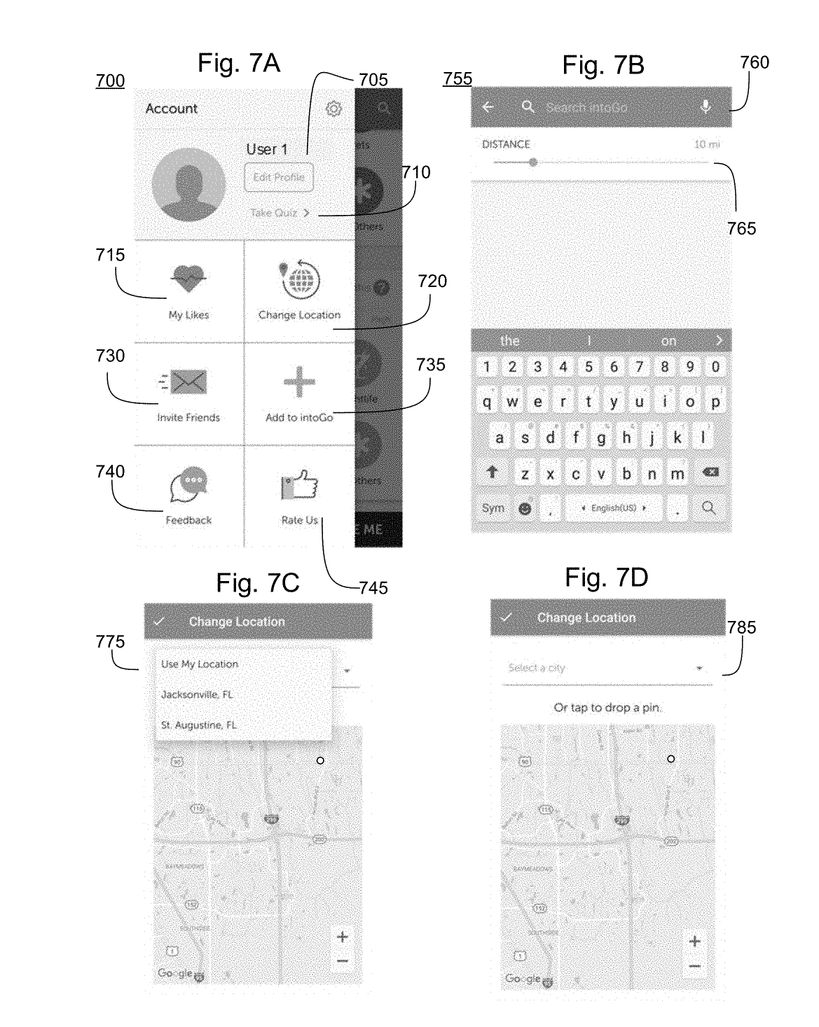

Referring now to FIG. 7A, an exemplary embodiment of a profile presentation 700 is illustrated. In some embodiments, a profile presentation 700 may include a profile module 705, a seed signal module 710, a saved preference profile 715, a location module 720, an invitation module 730, a contribution module 735, a feedback module 740, and a rating module 745. In some implementations, a user may input information into the profile module 705, including their name, their e-mail, their postal code, their birth date, their sex, preferring means of communication, preferred frequency of communication, connections to other profiles such as social media accounts or other profile-based systems, or monitoring their permissions, by way of non-limiting examples.

In some aspects, a profile module 705 may offer a user a snapshot of their preferences, for example, indicating to a user that their favorite experience is dining. In some embodiments, a user may set their favorite experiences within their profile module 705. In some implementations, other users may access and view certain aspects of a user's profile module 705. In some aspects, a user may set these permissions for what another user can see in a profile module 705. In some embodiments, a separate profile module 705 may exist from account settings (not pictured), which may contain more personal information to a user.

In some implementations, a user may access the seed signal module 710 to re-initiate, re-take, or correct their initial seed signal choices. In some aspects, a user may reinforce or recalibrate the seed signal by accessing the seed signal module 710 to more accurately reflect their preferences. In some embodiments, a user may access a different seed signal than they initially answered to ensure the quality and accuracy of their answers. In some implementations, the seed signal may be randomized each time to ensure the quality and accuracy of answers being entered into the system.

In some aspects, a user may access the saved preference profile 715 to review experiences they have taken actions on in the past. In some embodiments, a user may be presented with a list, a deck, or a card containing information about past experiences. In some implementations, a user may keep or change the answers they previously made about those experiences. In some aspects, a user may have stored certain experiences and offered a pending or tentative preference about the experience and may access the experience later to make a decision. In some embodiments, the saved preference profile 715 may break user preferences down into categories or sub-categories for ease of review. In some implementations, a user may search within the saved preference profile 715 if a user has several saved or stored experiences.

In some aspects, a user may access the location module 720 with functionality described in FIGS. 7B, 7C, and 7D below. In some embodiments, a user may access an invitation module 730. In some implementations, a user may invite or request other potential users to the platform. In some aspects, a user may invite another user by e-mail, social media, text message, contact list, or hyperlink by way of non-limiting example. In some embodiments, a user may invite another user to share in an experience. In some aspects, a user may invite groups or individuals who may not be enrolled in the guide system, wherein the invitation may allow for shared experiences and may prompt an invitation to join the guide system.

For example, a user may send an invitation to their friends list or followers on Facebook, Snapchat, or Instagram, wherein some friends may be users and some may not be enrolled. As another example, a user may Tweet an invitation to her followers, wherein the Tweet may include a link to the recipe or itinerary. In some aspects, that link may only be accessible to individuals who enroll in the guide system. In some embodiments, the link may allow for access or partial access to the recipe to those who are not yet enrolled, wherein partial access may allow for a read-only view, as a non-limiting example. In some implementations, friends may communicate with each other through a communication module, such as texting, video messaging, or instant messaging.

In some aspects, a user may be incentivized to be a brand ambassador. In some embodiments, these incentives may be triggered by a user delivering signals to the server a set number of times or giving more personal information to create a more individualized experience. In some implementations, a user may use internal systems, such as uploading a picture or leaving reviews, to receive points for prizes, such as a discount next time the user goes to their favorite restaurant. In some aspects, a user may unlock other events to attend by participating in activities driven to improving the database and overall communal user experience.

In some implementations, a user may access the contribution module 735. In some aspects, a user may contribute experiences to an experience database. In some embodiments, a user may submit experiences to a curator, who may review the experience and may add it to the experience database. In some implementations, a user may access the feedback module 740 to report on the experiences they have had, report on any potential bugs or glitches within the experience database, or otherwise give input to improve overall user accessibility. In some aspects, a user may access a rating module 745 to give a review on the system as a whole.

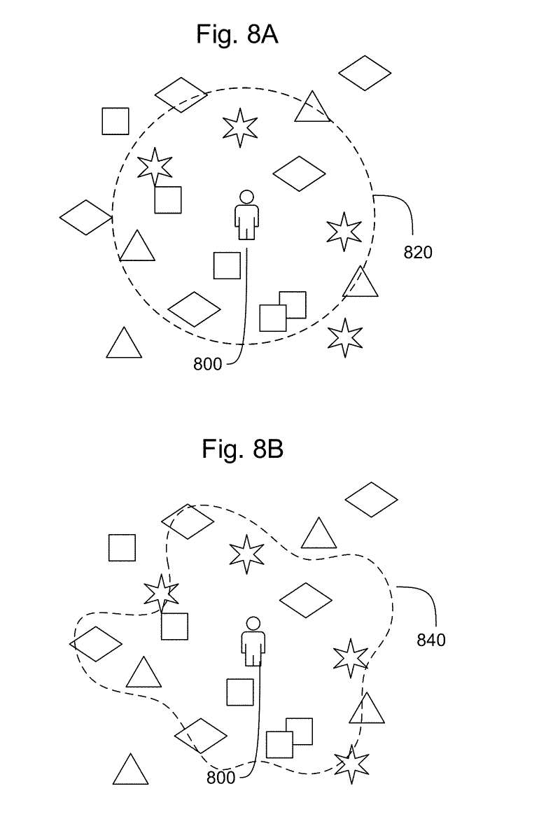

Referring now to FIGS. 7B-7D, exemplary embodiments of a location interface 755 are illustrated. In some embodiments, a user may access the location module 720 to transition to the location interface 755. In some implementations, a user may search for a location using a location search bar 760. In some aspects, a user may narrow a location range using a distance threshold meter 765. In some embodiments, a user may manipulate a location drop-down menu 775 to choose where to populate experiences. For example, a user may choose between using their current location as the epicenter for experiences, or they may choose a destination city they may be planning to travel to, such as Orlando, Fla., Atlanta, Ga., or Jacksonville, Fla. In some implementations, a user may choose a drop pin 785 to center their experience options around. As described below in FIGS. 8A-8B, the system may populate experiences depending on user or system preferences.

Referring now to FIGS. 8A-8B, exemplary embodiments of set radii are illustrated. In some embodiments, a user 800 may drop a pin to determine experiences around their location. In some implementations, the user may center the pin around a set radius 820, which may be directly surrounding the user's location or where the pin was dropped. In some aspects, the user may drop a variable radius 840. In some embodiments, the variable radius may be a hand drawn area or may be based on other boundaries, such as city limits, named parts of town, or where specific experiences might be located, as non-limiting examples.

In some implementations, a user may set the pin in an area they plan to be, with the resulting radius reflecting their preferences or later experience plans. In some aspects, the system may enhance or alter the radius based on trending experiences; community feedback; real-time occurrences, such as traffic, construction, or closed walkways; or user-set preferences, by way of non-limiting examples. In some embodiments, the system may have predefined geo-fencing built into certain areas, such as cities, townships, villages, communities, boroughs, as non-limiting examples. In some implementations, the system may analyze these options and combine them with a user's dropped pin to present a unified geo-fenced region.

In some aspects, not shown, a vendor or business may have access to a business dashboard, which may comprise a separate interface system than the guide me or explore interfaces. In some embodiments, a business may be able to at least partially control its presence within the guide system, wherein the control may be integrated into the marketing strategy of the business. In some implementations, the base components of a vendor profile may be similar to a user profile, wherein the vendor profile may comprise a location, name, preferred categories and meta-categories, as non-limiting examples. In some embodiments, a vendor may drop a pin and set a radius, such as a user may as illustrated in FIGS. 8A-8B.

For a business, the preferred categories and meta-categories may be directly input based on marketing strategy. In some aspects, signals may be discerned from marketing strategy activity that may allow the guide system to refine or suggest refinements to the strategy over time. In some implementations, the refinements may occur in real time, wherein a surging experience trend or other parameter changes may contemporaneously boost or diminish the marketing presence. For example, a sudden change in weather from sunny to stormy may prompt an increase in marketing activity for businesses that are associated with indoor experiences. As another example, where the business may comprise multiple locations, a surging trend in experiences related to a specific area of town may shift the marketing strategy to focus on advertisements for that area. In some implementations, signals can be used to create a highly targeted advertisement.

In some embodiments, a business or vendor may have a marketing subscription for the guide system, wherein the subscription level may determine their advertising options, such as frequency, duration, categories, meta-categories, users reached, result reporting, dynamic strategies, and marketing optimization, as non-limiting examples. For example, a lower subscription level may allow a business to select one meta category and a maximum frequency of five advertisements a day and up to two within an hour, wherein the ad may be pushed out to users who prefer that meta category and access experiences within that meta category from 3:00-5:00 pm.

A higher subscription level may allow a business more nuanced control over the marketing. For example, the business dashboard may present a real time effectiveness assessment of the current marketing strategy, wherein a business may elect to view or allow for real time optimization of the strategy. In some embodiments, a business may integrate a rewards or loyalty program, wherein users may earn cash, points, gift credits, or coupons, as non-limiting examples. In some implementations, a vendor, curator, or third-party may design an interactive activity that rewards repeat play or interactions with a coupon, promotion, or other incentive. In some aspects, the business dashboard may allow a vendor to select trigger events that may cause a surge or reduction in advertisement. As described above, the vendor may provide indoor experiences and may elect to change advertisement strategy at trigger times and trigger weather parameters. For example, during slower times, the vendor may send out coupons to entice more users to attend their experiences, or during sunny weather, the vendor may reduce the advertisements knowing their marketing budget may be better spent in other conditions.

In some embodiments, the vendor may be tangentially related to experiences, wherein the vendor may not be a direct experience provider or aggregator. For example, a banking institution may offer a credit card with a reward system related to travel, so their marketing strategy may target users with preferences for experiences related to travel. As another example, a car company may be promoting a rugged, off-roading sport utility vehicle, wherein they may target users who prefer experiences related to the outdoors, such as hiking or hunting sites or stores that specialize in outdoor equipment.

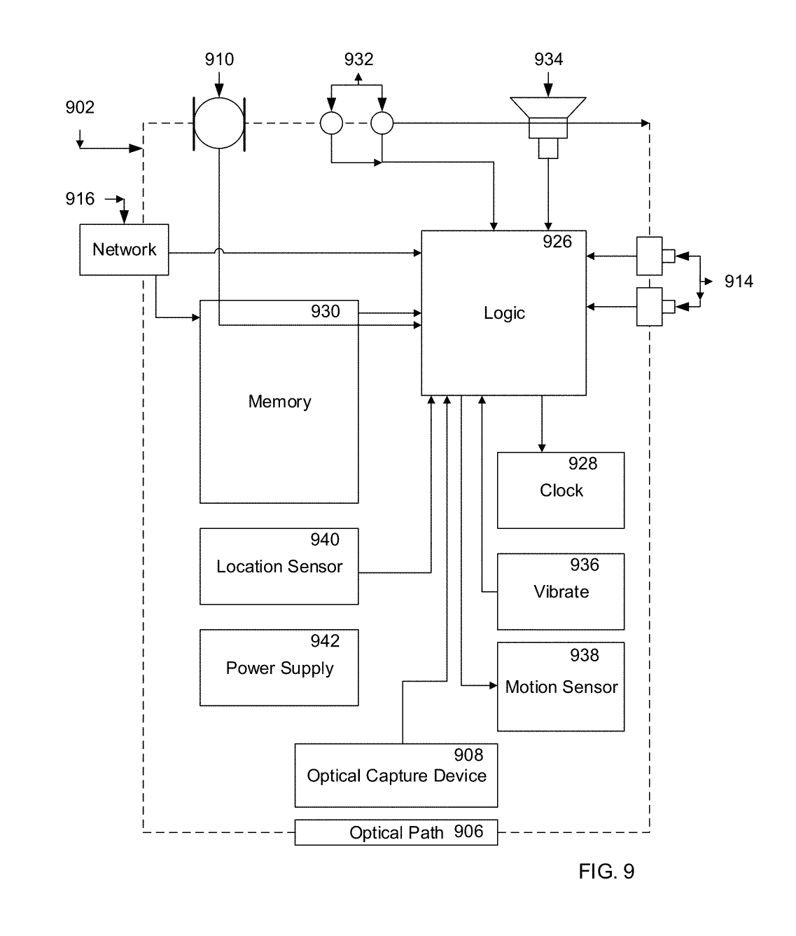

Referring now to FIG. 9, an exemplary block diagram of an exemplary embodiment of a mobile device 902 is illustrated. The mobile device 902 may comprise an optical capture device 908, which may capture an image and convert it to machine-compatible data, and an optical path 906, typically a lens, an aperture, or an image conduit to convey the image from the rendered document to the optical capture device 908. The optical capture device 908 may incorporate a Charge-Coupled Device (CCD), a Complementary Metal Oxide Semiconductor (CMOS) imaging device, or an optical sensor of another type.

In some embodiments, the mobile device 902 may comprise a microphone 910, wherein the microphone 910 and associated circuitry may convert the sound of the environment, including spoken words, into machine-compatible signals. Input facilities 914 may exist in the form of buttons, scroll-wheels, or other tactile sensors such as touch-pads. In some embodiments, input facilities 914 may include a touchscreen display. Visual feedback 932 to the user may occur through a visual display, touchscreen display, or indicator lights. Audible feedback 934 may be transmitted through a loudspeaker or other audio transducer. Tactile feedback may be provided through a vibration module 936.

In some aspects, the mobile device 902 may comprise a motion sensor 938, wherein the motion sensor 938 and associated circuity may convert the motion of the mobile device 902 into machine-compatible signals. For example, the motion sensor 938 may comprise an accelerometer, which may be used to sense measurable physical acceleration, orientation, vibration, and other movements. In some embodiments, the motion sensor 938 may comprise a gyroscope or other device to sense different motions.

In some implementations, the mobile device 902 may comprise a location sensor 940, wherein the location sensor 940 and associated circuitry may be used to determine the location of the device. The location sensor 940 may detect Global Position System (GPS) radio signals from satellites or may also use assisted GPS where the mobile device may use a cellular network to decrease the time necessary to determine location. In some embodiments, the location sensor 940 may use radio waves to determine the distance from known radio sources such as cellular towers to determine the location of the mobile device 902. In some embodiments these radio signals may be used in addition to and/or in conjunction with GPS.

In some aspects, the mobile device 902 may comprise a logic module 926, which may place the components of the mobile device 902 into electrical and logical communication. The electrical and logical communication may allow the components to interact. Accordingly, in some embodiments, the received signals from the components may be processed into different formats and/or interpretations to allow for the logical communication. The logic module 926 may be operable to read and write data and program instructions stored in associated storage 930, such as RAM, ROM, flash, or other suitable memory. In some aspects, the logic module 926 may read a time signal from the clock unit 928. In some embodiments, the mobile device 902 may comprise an on-board power supply 942. In some embodiments, the mobile device 902 may be powered from a tethered connection to another device, such as a Universal Serial Bus (USB) connection.

In some implementations, the mobile device 902 may comprise a network interface 916, which may allow the mobile device 902 to communicate and/or receive data to a network and/or an associated computing device. The network interface 916 may provide two-way data communication. For example, the network interface 916 may operate according to an internet protocol. As another example, the network interface 916 may comprise a local area network (LAN) card, which may allow a data communication connection to a compatible LAN. As another example, the network interface 916 may comprise a cellular antenna and associated circuitry, which may allow the mobile device to communicate over standard wireless data communication networks. In some implementations, the network interface 916 may comprise a Universal Serial Bus (USB) to supply power or transmit data. In some embodiments, other wireless links known to those skilled in the art may also be implemented.

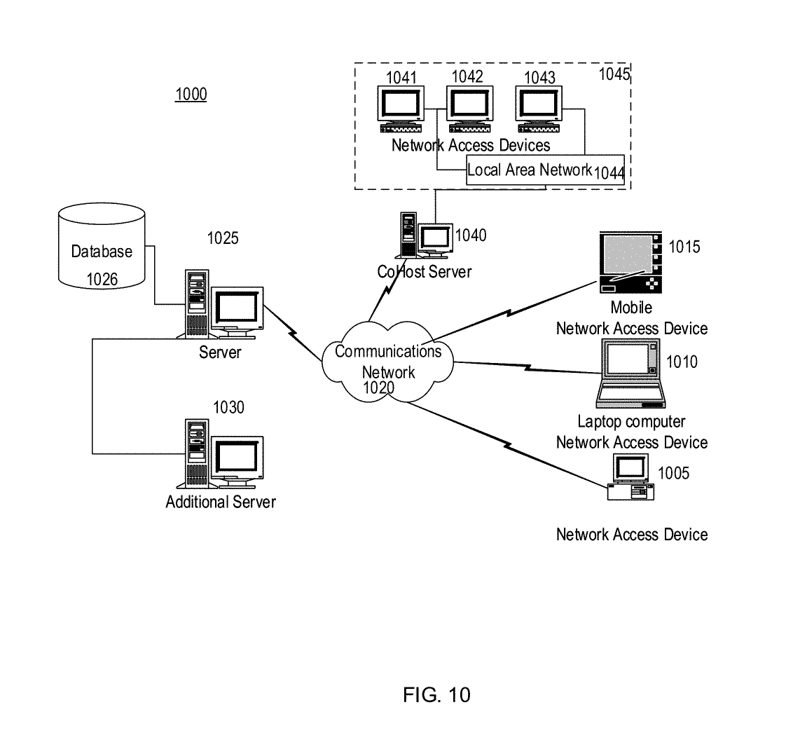

Referring now to FIG. 10, an exemplary processing and interface system 1000 is illustrated. In some aspects, access devices 1015, 1010, 1005, such as a paired portable device 1015 or laptop computer 1010 may be able to communicate with an external server 1025 through a communications network 1020. The external server 1025 may be in logical communication with a database 1026, which may comprise data related to identification information and associated profile information. In some embodiments, the server 1025 may be in logical communication with an additional server 1030, which may comprise supplemental processing capabilities.

In some aspects, the server 1025 and access devices 1005, 1010, 1015 may be able to communicate with a cohost server 1040 through a communications network 1020. The cohost server 1040 may be in logical communication with an internal network 1045 comprising network access devices 1041, 1042, 1043 and a local area network 1044. For example, the cohost server 1040 may comprise a payment service, such as PayPal or a social network, such as Facebook or a dating website.

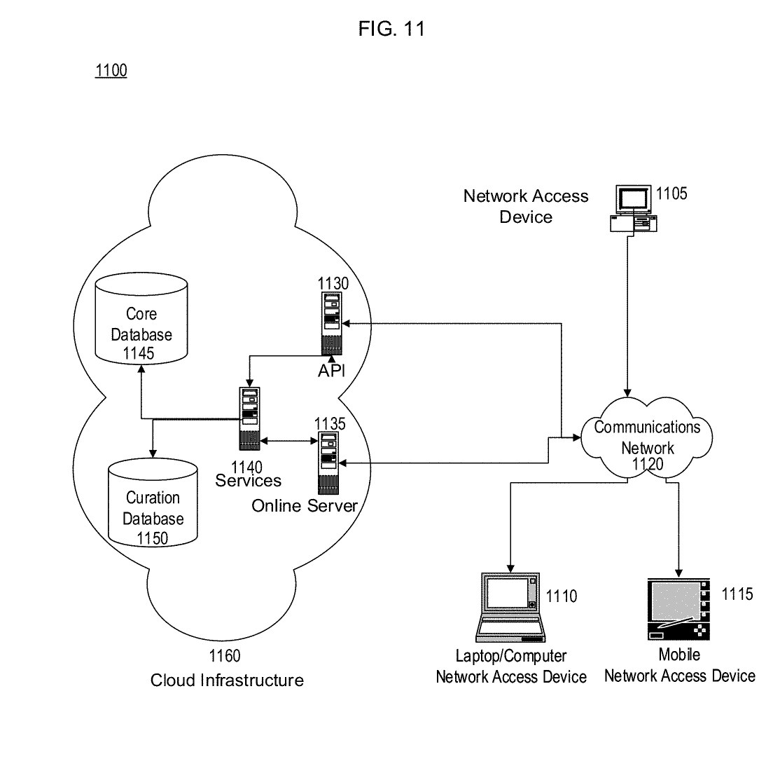

Referring now to FIG. 11, an exemplary processing and interface system 1100 is illustrated. In some embodiments, access devices 1105, 1110, 1115, such as a laptop computer 1110 or paired portable device 1115 may be able to communicate with an application program interface 1130, external servers 1135-1140 and a cloud infrastructure 1160 through a communications network 1120. In some implementations, externals servers may include an online processing server 1135 or a services server 1140. In some aspects, the services server 1140 may be in logical communication with a core database 1145 or a curation database 1150. In some embodiments, these logical communications may be taking place within a cloud infrastructure 1160. In some implementations, the services server 1140 may communicate information received or retrieved from the core database 1145 or curation database 1150 to the communications network 1120.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A computing system to provide an experience guide service, the computing system comprising:
a display;
one or more wireless communication interfaces;
one or more memory resources comprising:
an experience database configured to store a plurality of experiences;
a signal database configured to store a plurality of sets of signals from a plurality of users; and
one or more processors to:
collect experience data from one or more sources, wherein the experience data comprises one or both objective and subjective information about each of the plurality of experiences;
collect signal data from a plurality of users, wherein a first user of the plurality of users is associated with a first set of signals;
assign a first user value set to at least a first experience set of the plurality of experiences, wherein the first user value is calculated from the first set of signals; and
present the first experience set, wherein the presentation is based on the first user value set.

2. The computing system of claim 1, wherein the one or more processors are further configured to curate the experience data, wherein the curation evaluates the one or both objective and subjective information.

3. The computing system of claim 2, wherein the evaluation verifies the objective information.

4. The computing system of claim 2, wherein the evaluation associates the plurality of experiences with predefined categories based on the one or both objective and subjective information.

5. The computing system of claim 1, wherein the one or more processors are further configured to curate the experience data, wherein the curation isolates categories of objective parameters from the objective information about each of the plurality of experiences.

6. The computing system of claim 5, wherein the curation further validates the objective information about each of the plurality of experiences.

7. The computing system of claim 5, wherein the curation further isolates categories of the subjective information about each of the plurality of experiences and assigns category tags to each of the plurality of experiences.

8. The computing system of claim 7, wherein the one or more processors are further configured to assign a first user value set to the category tags.

9. The computing system of claim 8, wherein the presentation of the first experience set is further based on the category tags.

10. A method for presenting experience data, the method being performed by one or more processors and comprising the method steps of:
accessing an experience database comprising a plurality of experiences, wherein the experience database comprises one or both objective and subjective information about each of the plurality of experiences;
prompting signal input from a first user;
receiving a first set of signals from the first user;
assigning qualitative values to each signal within the first set of signals;
correlating the first set of signals to at least a portion of the plurality of experiences, wherein the correlation is based on the qualitative values and the one or both objective and subjective information;
assigning a first set of user values to at least the portion of the plurality of experiences, wherein the first set of user values are based on a strength of the correlation; and
presenting at least the portion of the plurality of experiences, wherein the presentation is organized based on the first set of user values.

11. The method of claim 10, further comprising the method steps of:
presenting a first experience from the plurality of experiences, wherein the prompting of at least one signal comprises a direct value indication for the first experience.

12. The method of claim 11, wherein the direct value indication comprises a directional slide of the presented first experience, wherein each direction indicates a different qualitative value.

13. The method of claim 11, further comprising the method steps of:
associating the first user with a first user group based on an overlap between at least part of the first set of signals and at least part of a first user group set of signals; and
retrieving a second set of user values associated with the first user group, wherein the presentation of at least the portion of the plurality of experiences is further organized based on the second set of user values.

14. The method of claim 12, further comprising the method steps of:
receiving a seed signal from the first user, wherein the associating of the first user with the first user group is further based on the seed signal.

15. The method of claim 12, further comprising the method steps of:
associating the subjective information with predefined category tags; and
correlating the first set of signals with the predefined category tags.

16. The method of claim 14, further comprising the method steps of:
prompting direct filtering based on the predefined category tags.

17. The method of claim 14, further comprising the method steps of:
predicting a third set of user values for the plurality of experiences based on the correlation of the first set of signals with the predefined category tags and the second set of user values.

18. The method of claim 10, further comprising the method steps of:
prompting direct input of objective parameters, wherein the presentation is one or both further organized or filtered based on the objective parameters.

19. The method of claim 10, wherein the qualitative values comprise one from the set of:
positive, negative, or neutral.

20. The method of claim 18, wherein a positive qualitative value is weighted as more or less positive based on a received input from the first user.
